(19) United States
(12) Patent Application Publication
(10) Pub. No.: US 2011/0072950 A1
(43) Pub. Date: Mar. 31, 2011

(54) CROSS-CUT, RIP-CUT, COMPOUND-MITER, TABLE SAW COMBINATION

(76) Inventor: Joseph A. IANNELLI, SR., Boynton Beach, FL (US)

(21) Appl. No.: 12/956,230

(22) Filed: Nov. 30, 2010

Related U.S. Application Data
(63) Continuation-in-part of application No. 12/275,197, filed on Nov. 20, 2008.
(60) Provisional application No. 61/376,259, filed on Aug. 23, 2010.
(60) Provisional application No. 61/384,277, filed on Sep. 19, 2010.

(51) Int. Cl. B26D 7/20

(52) U.S. Cl. 83/859

(57) ABSTRACT

A portable assembly is provided in which a power tool can be mounted on a rotatable plate. The plate is large enough to allow the saw to travel above a worksurface. When the plate is in a reference orientation, a workpiece on the support surface below the plate can be cross-cut or rip-cut. When the plate is offset from the reference orientation, the workpiece can be miter-cut, compound-miter cut, or rip-cut. When working with large workpieces, the plate with the power tool can be inverted, transforming the assembly into a table saw. The plate is preferably configured to allow popular sized power saws, jig saws, and routers to be mounted and used in the above manner. Multiple standard width guide plates can be provided with the assembly, to minimize the need to adjust the guide rails.

This application is a continuation-in-part of U.S. patent application Ser. No. 12/275,197, filed 20 Nov. 2008, which is incorporated by reference herein, and claims the benefit of U.S. provisional patent applications 61/081,385 filed 16 Jul. 2008, 61/097,855, filed 17 Sep. 2008, 61/376,259, filed 23 Aug. 2010, and 61/384,277, filed 19 Sep. 2010.

### BACKGROUND AND SUMMARY OF THE INVENTION

This invention relates to the field of power tools, and in particular to a portable assembly that allows a power hand saw, or other cutting tool, to be used as a cross-cut or miter saw, as well as a table saw.

The cost of power tools continues to increase, as does the space and weight that is consumed by the variety of specialized tools normally used in construction projects.

It would be advantageous to allow one power tool to perform multiple purposes, and in particular, it would be advantageous to allow a power hand saw, or other cutting tool, to be used as a cross-cut saw, a miter saw, and a table saw.

These advantages, and others, can be realized by a portable assembly in which a power saw can be mounted on a rotatable plate. The plate is large enough to allow the saw to travel above a worksurface. When the plate is in a reference orientation, a workpiece on the worksurface can be cross-cut or rip-cut. When the plate is offset from the reference orientation, the workpiece can be miter-cut or rip-cut. When working with large workpieces, the plate with the power saw can be inverted, transforming the assembly into a table saw. The plate is preferably configured to allow popular sized power saws, jig saws, and routers to be mounted and used in the above manner; or, multiple plates can be provided with the assembly.

### BRIEF DESCRIPTION OF THE DRAWINGS

The invention is explained in further detail, and by way of example, with reference to the accompanying drawings wherein:

FIGS. 1A-1C illustrate an example cross-cut, rip-cut, miter, table saw assembly.

FIGS. 2A-2B illustrate an example invertable and rotatable plate.

FIGS. 3A-3F illustrate an example plate with power tools.

FIGS. 4A-4B illustrate example attachment elements for attaching a power tool to the rotatable plate.

FIGS. 5A-5B illustrate an example adjustment of guides to accommodate a power tool.

FIG. 6 illustrate an example guide plate.

FIGS. 7A-7C illustrate an example support plate and fences.

FIG. 8 illustrates an example extendable assembly.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

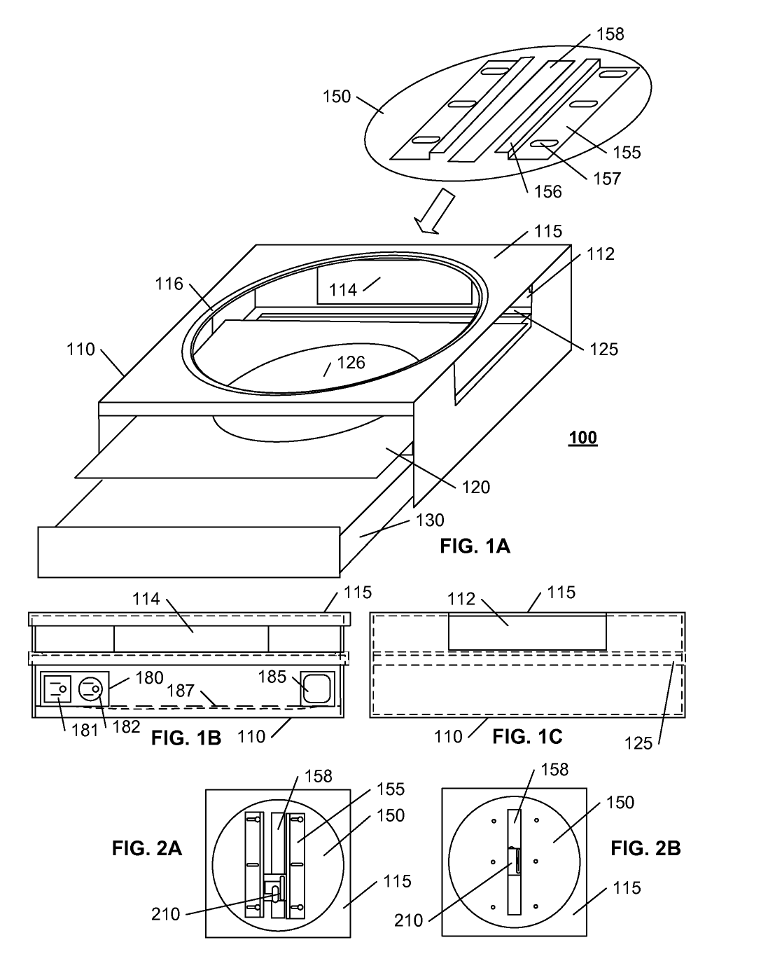

FIG. 1A illustrates a perspective view of an example cross-cut, rip-cut, miter-cut, and table saw assembly 100 in accordance with aspects of this invention. FIG. 1B illustrates a rear view, and FIG. 1C illustrates a side view. Because the assembly 100 is symmetric, the user may choose which side is the ‘front’; that is, which side the user will typically face when operating the tool. Note that particular features of the assembly 100, detailed below, are not illustrated, so as not to detract from an understanding of the basic principles of this invention. The parent application of this continuation-in-part includes details regarding similar features, and is published as USPA 2010/0011929, dated 21 Jan. 2010.

A base 110 includes a base top 115 with a circular opening 116 that is arranged to accept a circular plate 150 that is configured to guide and/or support a power tool, such as a power saw, jig saw, router, and so on. The plate 150 includes a slot 158, and a pair of guides 155 on either side of this slot 158. In this example, the guides 155 are configured to allow a base plate of the power tool to fit below a portion 156 of the guides 155, as detailed further below. One of skill in the art will recognize, however, that the guides 155 could be shaped without this overlapping portion 156. One of skill in the art will also recognize that a single guide 155, with or without portion 156, may be used, wherein the user guides the power tool against the guide 155 as it is pushed across the plate 150. The example guides 155 include slots 157 for receiving a fastening element that allows for adjusting the guides 155 to accommodate particular tools, as detailed further below.

In accordance with an aspect of this invention, the plate 150 includes features that allow the power tool to be fixedly attached to the plate 150, detailed further below. When the power tool is affixed to the plate 150, the plate 150 with the attached power tool can be placed in the circular opening 116 in an inverted position, with the operational element (saw blade, router bit, etc.) facing up. This inverting capability allows the assembly 100 to be used as a table-saw, a routing table, and so on. Advantageously, in this inverted configuration, large workpieces can be accommodated. For ease of understanding, the term ‘table-saw’ is used to identify the configuration wherein the operational element is facing up, regardless of the particular type of power tool being supported by the plate 150. In like manner, the term ‘blade’ is used to identify the operational element, regardless of the particular type of operational element (saw blade, router bit, etc.).

FIG. 1B illustrates example electrical connections for providing power to the tool. In this example, an outlet box 180 is configured to include a male plug 181 for receiving an extension cord that is plugged into a source of power, and a female outlet 182 for receiving the plug of the power cord of the tool. The plug 181 and outlet 182 are preferably coupled via a power switch 185. To facilitate emergency shut-off, the power switch 185 is preferably a push-pull switch, wherein when it is pushed in power is shut off, when it is pulled out, power is provided to the outlet 182. Other configurations for providing power will be evident to one of skill in the art.

FIG. 2A illustrates a top view of the assembly 100 when a power tool 210 is atop the support 150, in the non-inverted configuration, herein termed the ‘blade-down’ position. FIG. 2B illustrates a top view of the assembly 100 when the power tool 210 is attached to the support 150 and the support 150 is in the inverted, table-saw configuration.

Returning to FIGS. 1A-1C, the example assembly 100 includes a removable workpiece support 120, and workpiece openings 112 that allow the workpiece to be placed beneath the plate 150 when the plate 150 is used in the blade-down position. The support 120 is supported by rails 125. The example workpiece support 120 is illustrated with a circular kerf opening 126 that allows the blade of the power tool to extend below the workpiece. In a preferred embodiment, a variety of kerf plates may also be provided for placement in the opening 126, to optimize support for the workpiece for particular tasks. For example, if the assembly is being used to perform cross-cuts while in a reference orientation (e.g. normal to the front of the assembly 100), a kerf plate with a single kerf slot that extends from front to rear may be used. In accordance with an aspect of this invention, the assembly 100 also includes openings 114 that allows the workpiece to travel from front to rear of the assembly for performing rip cuts while the plate 150 is in this same reference position, using this same kerf plate.

The workpiece support 120 is also preferably configured to support a fence, not illustrated, for orienting or guiding the workpiece beneath the plate 150. Preferably, two types of fences are provided. For cross-cuts and miter-cuts, wherein the workpiece is introduced via the side openings 112, a pair of removable fence portions are attached to either the support 120 or the aforementioned kerf plate on either side of the kerf slot or opening, parallel to the front of the assembly 100. For rip-cuts wherein the workpiece is introduced via the front or back openings 114, a movable fence that extends from front to rear of the assembly 100 is used. Such a fence may be structured to clamp to the front and rear surfaces of the base 110, at the lower edge of the openings 114, as detailed below.

The opening 126 in the support 120 also provides clearance for the power tool when the assembly 100 is used in the table-saw configuration, in most cases. If the power tool does not fit within the opening 126, the support 120 can be removed.

In a preferred embodiment, the assembly 100 also includes a removable drawer 130. This draw 130 advantageously collects the saw dust or other waste material produced while working on the workpiece. This drawer 130 may also include covered partitions for storing small tools, preferably outside the region where most of the waste will fall. The drawer 130 may also include a hose attachment at the rear, for coupling to a shop-vac or other waste collecting device.

In operation, the assembly 100 will generally be used in the blade-down configuration for cutting lumber and boards, and in the table-saw configuration for cutting sheet material. Rip cutting can be performed in either configuration, depending upon the width of the workpiece and the width of the rip. It is envisioned that this invention will be embodied in at least two sizes, an all-purpose size, and a smaller utility size. To accommodate a variety of tool in the table-saw configuration, the base unit 110 in each size will be about 8″ tall.

In the all-purpose size, because common board sizes extend up to 2″×12″ (1½″×11½″ finished), the size of the openings 112 and 114 is preferably at least 2″×12″; for ripping, the board may be offset, so the front and rear openings 114 are preferably wider than 12″. That is, assuming that the saw blade is in the center, an opening 114 of 23″ will allow the 12″ (11½″) board to be ripped on either side of the blade. In like manner, power saw blades are typically 8″ in diameter; accordingly, the length of the slot 158 is preferably at least 24″ (8″ start location of saw, 12″ travel, 4″ end location of saw). Thus, the base unit of the all-purpose size will be in the order of 30″×30″.

The smaller utility size is designed for the most common applications, using, for example, 2″×8″ as the largest board size that should be accommodated. In this case, the openings 112 are preferably 2″×8″, and the openings 114 are preferably 2″×16″. The slot 158 may be 20″ long (8″ start+8″ travel+4″ end), although a shorter length may be sufficient due to the fact that the full width/diameter of the blade does not extend below the saw, and the nominal 8″ board is 7½″ wide). In a preferred embodiment of the utility size embodiment, the slot 158 is about 3″ wide and 18″ long. Thus, the base unit of the all-purpose size will be in the order of 24″×24″.

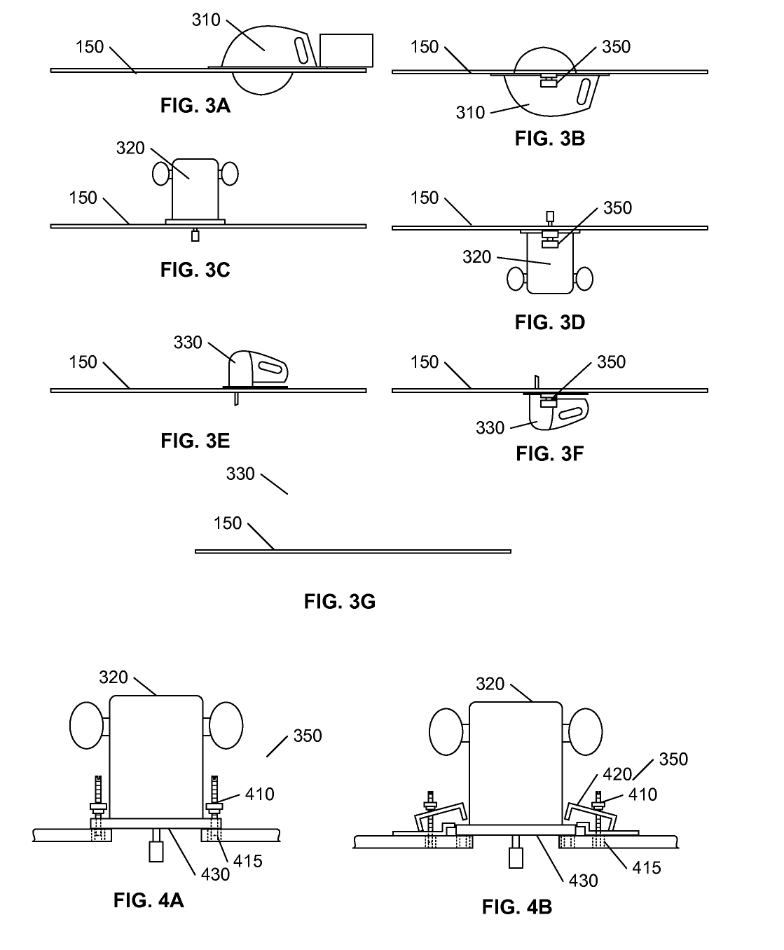

FIGS. 3A-3F illustrate a variety of example configurations of different power tools with respect to the support 150.

FIGS. 3A-3B illustrate a power saw 310 in the non-inverted, blade-down configuration, and in the inverted, table-saw configuration. FIGS. 3C-3D illustrate a router 320 in the non-inverted, blade-down configuration, and in the inverted, table-saw configuration. FIGS. 3E-3F illustrate a jig-saw 330 in the non-inverted, blade-down configuration, and in the inverted, table-saw configuration. In the table-saw configuration, a fastening device 350 affixes the tool 310, 320, 330 to the support plate 150.

FIG. 4A illustrates an example attachment of a router 320 to the plate 150. In this embodiment, the router is attached via mounting holes 435 in the plate 430 of the router 320. A thumbscrew 410 extends into receptors 415 in the plate 150. In a preferred embodiment, the receptors 415 are situated in tracks that allow them to be spaced appropriately to align with the holes 435 in the plate 430.

FIG. 4B illustrates another example attachment of the router 320 to the plate 150 via fastening devices 350. As in the example of FIG. 4A, a thumbscrew 410 extends into receptors 415 in the plate 150. Referring to FIG. 1, these receptors 415 may be placed below the center slots 157 in the guides 155, allowing the tool to be fastened to the plate 150 without removing the guides 155. As illustrated in FIG. 4B, the fastening device 350 includes a U-shaped element 420 that is configured to apply pressure to the base 430 of the router 320 when the thumbscrew 410 is tightened. One of skill in the art will recognize that other tool attachment techniques, common in the art, may alternatively be used.

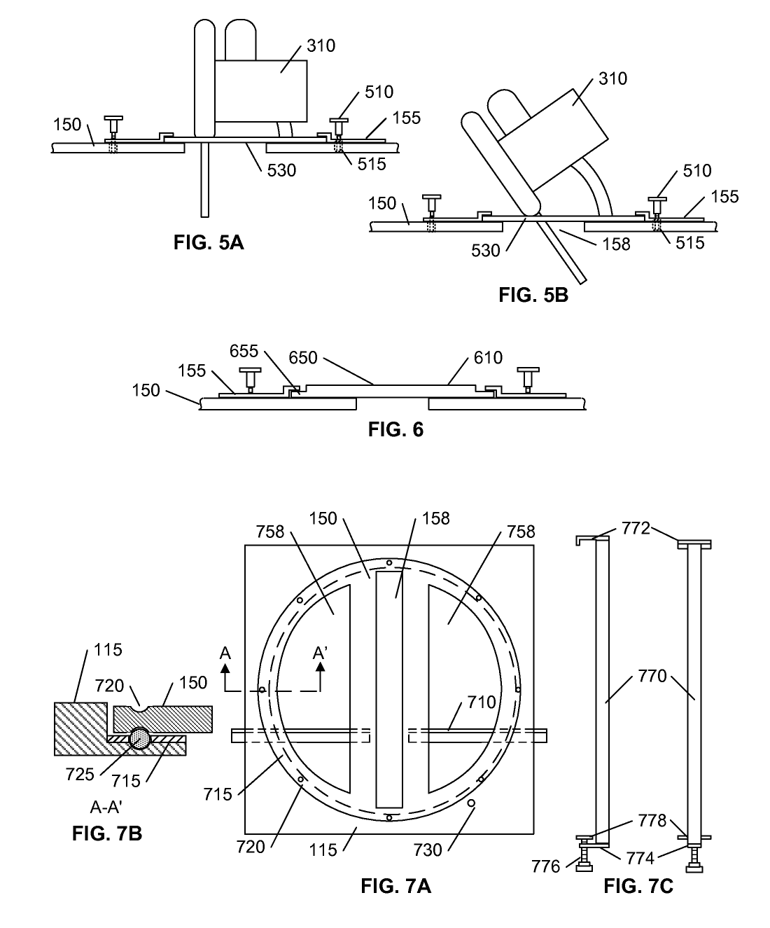

FIGS. 5A-5B illustrates the use of the guides 155 when a power saw 310 is used in the blade-down configuration of the assembly 100. In these examples, thumbscrews 510 extend into receptors 515 in the plate 150, through the slots 157 (FIG. 1) in the guides 155. As noted above, the slots 157 allow the guides to be adjusted to accommodate the particular size of the plate 530 of the power saw 310. When the guides are in the appropriate locations, the thumbscrews 510 are tightened to hold the guides in their proper place, The overlapping portions 156 of the guides 155 are shaped to overlay the plate 530, yet allow the saw 310 to be pushed along the guides 155 by the user. As also noted above, these overlapping portions 156 are optional, as is the use of two guides 155.

As illustrated in FIG. 5B, the opening 158 in the support plate 150 is sized sufficiently to allow the power saw 310 to be tilted, thereby allowing for angled cuts as well as compound-miter cuts.

In a preferred embodiment of this invention, spacers may be provided to elevate the guides 155 above the surface of the plate 150, allowing for different thicknesses of plates 530.

As will be evident to one of skill in the art, some tools may not have a plate that is suitable for use with the guides 155, or suitable for use with the fastening device 350 (FIG. 3). In a preferred embodiment of this invention, a guide plate may be provided to facilitate the use of a variety of tools.

FIG. 6 illustrates an example guide plate 610. The guide plate 610 is illustrated as having tongues 655 that fit within the guides 155, and a thicker region 650 that supports the tool and allows it to extend above the guides 155, as required. Preferably, the plate will be made of a workable material, such as plastic, so that the user can form the appropriate cutouts and attachment holes. A plurality of guide plates 610 may be provided with the assembly 100 so that the user can attach the plates 610 to a variety of tools. In this manner, if each guide plate is the same width, adjustments to the guide rails for different tools will not be required.

FIG. 7A illustrates an example support plate 150 with cutouts 758 that facilitate viewing of the workpiece (not illustrated) while it is placed in position along a set of removable fences 710. The fences 710 are removable in order to allow the workpiece to be introduced from the front or rear for rip-cuts, without rotating the saw. The guides 155 are not illustrated in this figure, so as not to obscure the figure, but they would be positioned on the surface on either side of the slot 158.

Also illustrated in FIG. 7A are detents 720 that facilitate positioning of the support plate 150 on the top surface 115 of the assembly 100. In this example embodiment, the top 115 includes a ledge 715 that supports the rotatable plate 150. FIG. 7B illustrates a cross section view of the top 115 with the plate 150 situated on the ledge 715. To facilitate adjustment of the rotatable plate 150, the ledge 715 includes bearings 725 at the locations of the detents 720. As the plate 150 is rotated, it will either be rotatably supported by these bearings 725, or fixedly supported as the bearings 725 engage the detects 720. The detents 720 are situated on both sides of the plate 150, so that they can engage the bearings in both the non-inverted blade-down configuration and the inverted table-saw configuration.

The detents 720 are illustrated as being spaced at 45° around the support plate 150, although other spacings may be used as well. In this manner, the plate 150 can be easily placed at the reference orientation for crosscuts and ripcuts and a 45° orientation for mitered corner cuts. At other angles, one or more receptors 730 are situated on the top 115, near the perimeter of the plate 150. As in FIG. 4, a fastening device 350, comprising a thumbscrew 410 and U-shaped element 420 can be used to apply pressure to the plate 150 to hold it at the desired angle. Not illustrated in FIG. 7A, the plate 150 or the top 115 is preferably labeled or engraved with graduation marks around at least a section of the perimeter of the plate, indicating the relative angle of the plate 150 with respect to the top 115, and, correspondingly, relative to the fence 710. Also in a preferred embodiment of this invention, linear graduation marks are places along the edges of the top 115, to facilitate measuring and marking the workpiece without a separate measuring device.

FIG. 7C illustrates a fence 770 that can be used on the top 115 when the assembly 100 is in the blade-up table-saw configuration, or on the support 120 when ripping in the blade-down configuration. The fence 770 includes a rear flange 772 that includes a lip for wrapping around the edge of the top 115, or the rear support rail 125 for the support 120 (FIG. 1). The fence 770 also includes a front flange 774 with a thumbscrew that can apply pressure to the front edge of the top 115, or the edge of the front support rail 125.

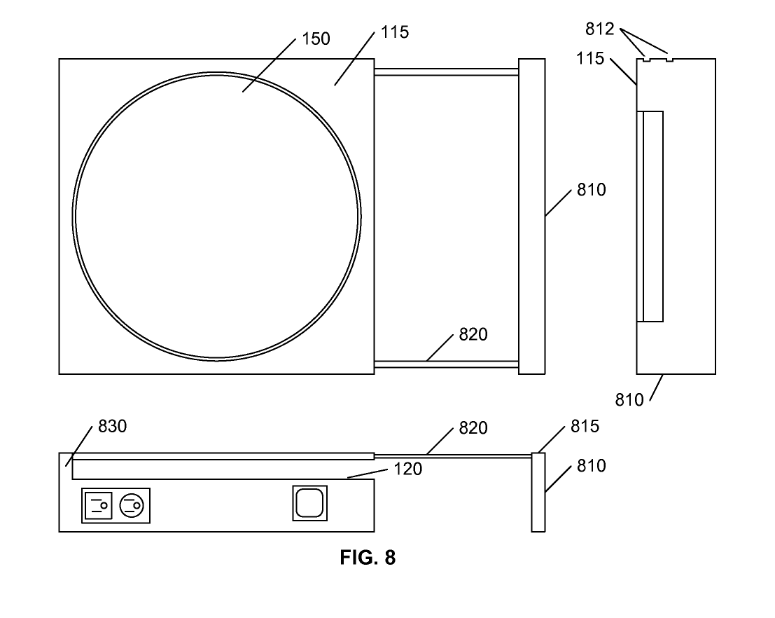

To support large workpieces, such as plywood sheets, FIG. 8 illustrates an assembly with extendable supports 810. In this example embodiment, a pair of telescopic rods 820 allows the support 810 to be extended to an appropriate width so that the upper surface 815 of the support 810 is able to support the workpiece. Also illustrated in FIG. 8, the support 810 includes notches 812 that facilitate the use of the example fence 770 in FIG. 7. As compared to the example of FIG. 1, the example of FIG. 8 illustrates a thinner support wall 830, allowing for wider workpieces at the lower worksurface 120.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the example embodiments include a circular support plate that facilitates miter cuts, although one of skill in the art will recognize that a simpler embodiment may provide for cross-cuts, rip-cuts, and table-saw features, without the miter feature, obviating the need for a circular support plate. Because such an embodiment would not necessarily require symmetry, the aspect ratio of the assembly could be optimized for a particular set of tasks. For example, a long and narrow assembly could provide the length needed for cross cutting wide boards when the blade is parallel to the long dimension, and with the blade perpendicular to the long dimension, could provide the width needed to support wide sheet material in the table-saw configuration. Also, an alternative for the cutouts in the support plate is the use of a relatively transparent material to form the support plate, such as glass, plexiglas, or other polycarbonates. The top of the base may also comprise transparent material. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may include a processor, and software portions may be stored on a non-transient computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise;

i) no specific sequence of acts is intended to be required unless specifically indicated; and

j) the term “plurality” of an element includes two or more of the claimed element, and does not imply any particular range of number of elements; that is, a plurality of elements can be as few as two elements, and can include an immeasurable number of elements.

I claim:

1. An assembly comprising:
a base unit that includes:
a top element with an opening, and
a workpiece support below the top element, and
a support plate that is configured to be supported by the top element around the perimeter of the opening;
wherein:
the support plate is configured to:
provide a guide for a power tool as the power tool travels across the support plate, and
provide a fastening device that is configured to facilitate fixedly attaching the power tool to the support plate, and
the support plate can be placed on the top surface in a non inverted configuration in which the operational element of the power tool extends down from the support plate toward the workpiece support, and in an inverted configuration in which the operational element of the power tool extends up from the support plate.

2. The assembly of claim 1, wherein the support plate is circular, and rotatable with respect to the top element, to facilitate miter cuts.

3. The assembly of claim 2, wherein the top element includes bearings to facilitate rotation of the support plate.

4. The assembly of claim 3, wherein the support plate includes detents that are configured to engage the bearings, thereby facilitating fixing the support plate at a select orientation with respect to the top element.

5. The assembly of claim 2, including an element that facilitates fixing an orientation of the support plate relative to the top element.

6. The assembly of claim 1, wherein the support plate includes cutouts that facilitate viewing of a workpiece when the workpiece is on the workpiece support.

7. The assembly of claim 1, wherein the workpiece support is easily removable.

8. The assembly of claim 1, wherein the assembly includes an opening at each of four sides, allowing the workpiece to be introduced through each of these openings.

9. The assembly of claim 1, including a reference orientation of the support plate relative to the base unit for performing cross-cuts, wherein the assembly is configured to allow the workpiece to be rip-cut while the support plate is in the reference orientation.

10. The assembly of claim 1, wherein the support plate includes a blade opening that is wide enough to allow the power tool to be tilted relative to a surface of the support plate, thereby facilitating compound-miter cuts.
